(19) United States
(12) Patent Application Publication
(10) Pub. No.: US 2012/0242649 A1
(43) Pub. Date: Sep. 27, 2012

(54) METHOD AND APPARATUS FOR CONVERTING 2D IMAGES INTO 3D IMAGES

(76) Inventor: Chi-Wen SUN, Taipei City (TW)

(21) Appl. No.: 13/053,918

(22) Filed: Mar. 22, 2011

(51) Int. Cl. G06T 15/00

(52) U.S. Cl. 345/419

(57) ABSTRACT

The present invention discloses a method and an apparatus for converting 2D images into 3D images, comprising: an original image, serving as first-eye image information; an in-depth image, serving as second-eye image information, and the in-depth image having a primary target area and a secondary target area, and the secondary target area being disposed at a position extended from an edge of the primary target area, and the primary target area using finer pixels as a computing unit for a 2D-image object depth computation, and the secondary target area using pixels larger than those of the primary target area as a computing unit for the 2D-image object depth computation, wherein the original image and the in-depth image are combined into a 3D image, such that the 3D images can be produced by lower-priced computing resources.

### BACKGROUND OF THE INVENTION

1. Field of the Invention

The present invention relates to an image capturing device and an image correction thereof, and more particularly to an image capturing device and an image correction thereof that rotationally correct a captured image to match an image captured by the image capturing device at a preset angle.

2. Description of the Related Art

As early as 1936, movies with 3D effects adopted a dual-lens camera and a polarizer for their production. However, such method cannot be used extensively due to technical limitations. In recent years, 3D movies such as “Avatar” are widely acclaimed, and thus promoting 3D movies becomes an important trend of the technical development of multimedia images. Since the 3D movies incur a high cost and takes much time, and a 3D television at a price of hundreds of thousand of NT dollars has not reached the economic scale yet, therefore continual researches and efforts are invested before the 3D video becomes popular. On the other hands, the source of 3D movies is very insufficient, which is also an obstacle to the promotion of the 3D video. Therefore, the technology of converting 2D images to 3D images is introduced, such that images of a huge 2D movie, a PC game, or a photo can be converted into a 3D image content, or even the content of a broadcasted television program can adopt this technology to convert a 2D screen into a 3D screen.

The conventional technology of converting 2D images to 3D images usually uses the production of an image depth map, such that the parallax is produced by both eyes to have the 3D image effect. However, when the depth of the 2D-image object is computed in the prior art, the computation is conducted in a full screen by using 1×1 or 2×2 pixels as a unit, so that a large computing resource is used, or even a specified video chip or video card is required for completing the computation of the depth of the 2D-image object, and the computation requires a specific device and a high cost, and thus this method fails to meet the cost-effective requirement and cannot be used extensively. Obviously, the prior art requires further improvements and feasible solutions.

According to the theory of visual psychology, people have a primary target area (such as an eye-catching area, a focus area or a core area) in a scene perceived their eyes, and the primary target area is out most attentive area. If the primary target area of our vision in accordance with the theory of visual psychology is applied and combined with the technology of converting 2D images to 3D images, each instant screen can produce a 3D image effect with a primary target area of the vision without the need of using lots of computing resources, and all instant screens are processed by the 3D image processing of equal primary target areas. Therefore, an efficient visual application can be achieved to meet the cost-effective requirement and promote the application of converting 2D images to 3D images.

In view of the shortcoming of the conventional technology of converting 2D images into 3D images, the inventor of the present invention based on years of experience in the related industry, and conducted extensive researches and experiments, and finally designed and developed a method and an apparatus of converting 2D images into 3D images with a more cost-effective, efficient and smoother operation to overcome the shortcomings of the prior art.

### SUMMARY OF THE INVENTION

Therefore, it is a primary objective of the present invention to use the primary target area of our vision in accordance with the theory of visual psychology together with the technology of converting 2D images to 3D images to produce the 3D image effect with the primary target area by consuming less computing resources, so as to achieve a high cost-effectiveness of producing 3D images and favor the promotion the application of converting 2D images into 3D images.

Another objective of the present invention is to process a 3D image of different levels of the primary target area and secondary target area after a 2D image is set at different levels of the primary target area of different movie types, so as to achieve the effects of converting 2D images into 3D images, providing a satisfactory 3D image effect for our vision, and saving lots of computing resources.

To achieve the foregoing objective, the present invention provides a method comprising the steps of: (1) selecting a movie type; (2) detecting a primary target area of a movie according to the movie type, and setting a secondary target area, wherein the secondary target area is disposed at a position extended from an edge of the primary target area; (3) performing a computation of the depth of the 2D-image object of the primary target area and the secondary target area, wherein the primary target area uses a smaller pixel as a computing unit to compute the depth of the 2D-image object, and the secondary target area uses a larger number of pixels than that of the primary target area as a computing unit to compute the depth of the 2D-image object.

The method of the present invention further comprises: an original image, serving as first-eye image information; an in-depth image, serving as second-eye image information, wherein the in-depth image is obtained by performing a depth computation process to the original image, and the in-depth image has a primary target area and a secondary target area, and the secondary target area is disposed at a position extended from an edge of the primary target area, and the primary target area uses a smaller pixel as a computing unit to compute the depth of the 2D-image object, and the secondary target area uses a larger number of pixels than that of the primary target area as a computing unit to compute the depth of the 2D-image object; and the original image and the in-depth image are combined into a 3D image.

The method of the present invention further comprises: an in-depth image which is obtained by performing a depth computation process to an image, and the in-depth image has a primary target area and a secondary target area, and the secondary target area is disposed at a position extended from an edge of the primary target area, and the primary target area uses a smaller pixel as a computing unit to compute the depth of the 2D-image object, and the secondary target area uses a larger number of pixels than that of the primary target area as a computing unit to compute the depth of the 2D-image object.

To achieve the foregoing objectives, the present invention provides an apparatus comprising: a conversion box, wherein the conversion box adopts the aforementioned method of converting 2D images into 3D images, and the conversion box includes a 3D function key or a plurality of selection keys, and the 3D function key and the plurality of selection keys are integrated with the method of converting 2D images into 3D images, and the selection key is used for selecting and setting a movie type.

The apparatus of the present invention further comprises: a play and display device, wherein the play and display device adopts the aforementioned method of converting 2D images into 3D images. The apparatus of the present invention further comprises: an interface card, and the method of converting 2D images into 3D images is written into a chip or a plurality of chips, and the chip is installed in the interface card.

To make it easier for our examiner to understand the technical characteristics and effects of the present invention, we use preferred embodiments together with related drawings for the detailed description and illustration of the invention as follows.

### BRIEF DESCRIPTION OF THE DRAWINGS

FIG. 1 is a flow chart of a method of converting 2D images into 3D images in accordance with the present invention;

FIG. 2 is a schematic view of setting a pixel area in accordance with the present invention;

FIG. 3 is a schematic view of using a computing unit in accordance with the present invention;

FIG. 4 is a flow chart of converting 2D images into 3D images in accordance with a preferred embodiment of the present invention;

FIG. 5 is a schematic view of an image processing device of a method of converting 2D images into 3D images in accordance with a first preferred embodiment of the present invention; and

FIG. 6 is a schematic view of an image processing device of a method of converting 2D images into 3D images in accordance with a second preferred embodiment of the present invention.

### DETAILED DESCRIPTION OF THE PREFERRED EMBODIMENTS

The technical characteristics and effects of the present invention will be apparent with the detailed description of preferred embodiment together with the illustration of related drawings as follows.

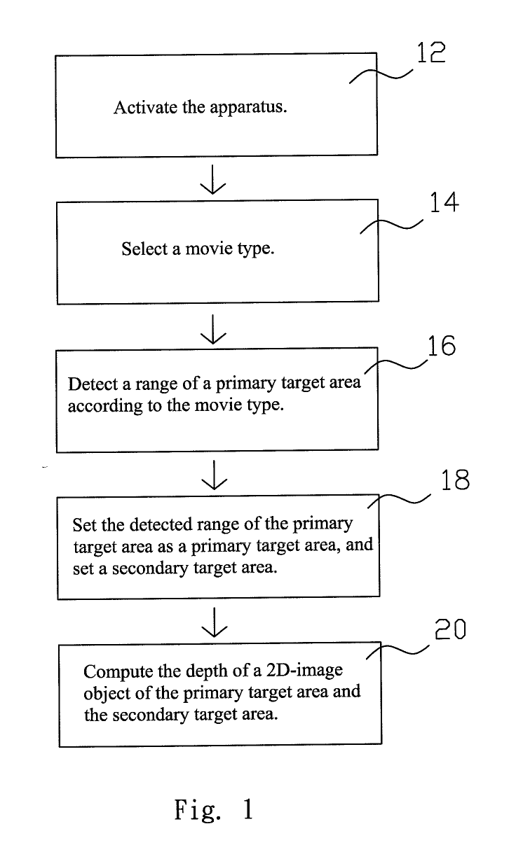

With reference to FIG. 1 for a flow chart of a method of converting 2D images into 3D images in accordance with the present invention, the method comprises the following steps: (1) Activate a device 12, which is a 3D image processing device or program, and the program is stored in a chip and installed in an image processing or display device; (2) Select a movie type 14; which usually includes news, sport, movie, advertisement, adult, general or other movie types, and the movie type can be selected and set by a manual key or a software function, and the method of this invention will set the general movie type as the default setting, if this step is omitted default; (3) Detect a range of the primary target area according to the movie type, wherein the method for detecting the range of the primary target area used by various movie types is described below:

For the news type, face detection is used, and the detected area is set as the range of the primary target area.

For sport type, body detection or ball detection is used, and the detected area is set as the range of the primary target area.

For movie type, face detection is used, and the detected area is set as the range of the primary target area.

For advertisement type, text detection is used, and the detected area is set as the range of the primary target area.

For adult type, skin detection, face detection, or body detection is used, and the detected area is set as the range of the primary target area.

For general type, face detection is used, and the detected area is set as the range of the primary target area.

The detection method for each movie type is not limited to the aforementioned arrangements only, but a combination of detection methods or an equivalent method can be used as well.

The aforementioned method for detecting the range of the primary target area such as the face detection method is to trace two black spots in an image. Assumed that the two black spots are eyes, and these two black spots are connected to form a line segment, and if an object line a mouth is disposed at a position perpendicularly below the middle of the line segment and a distance equal to the length of the line segment, then the object is determined as a face, and the face is the range of the primary target area. For a skin color detection method, a pixel in the image is converted from a RGB color space into a HSV (Hue, Saturation, Value) color space, and then the HSV value of the pixel is compared to determined whether or not it falls within a color skin range. If the HSV value falls within the color skin range, then the object is determined as a skin block, or else a non-skin block. This skin block is the range of the primary target area. In the foregoing face detection, body detection, ball detection, text detection, and skin detection methods are prior arts, and will not be described in details here.

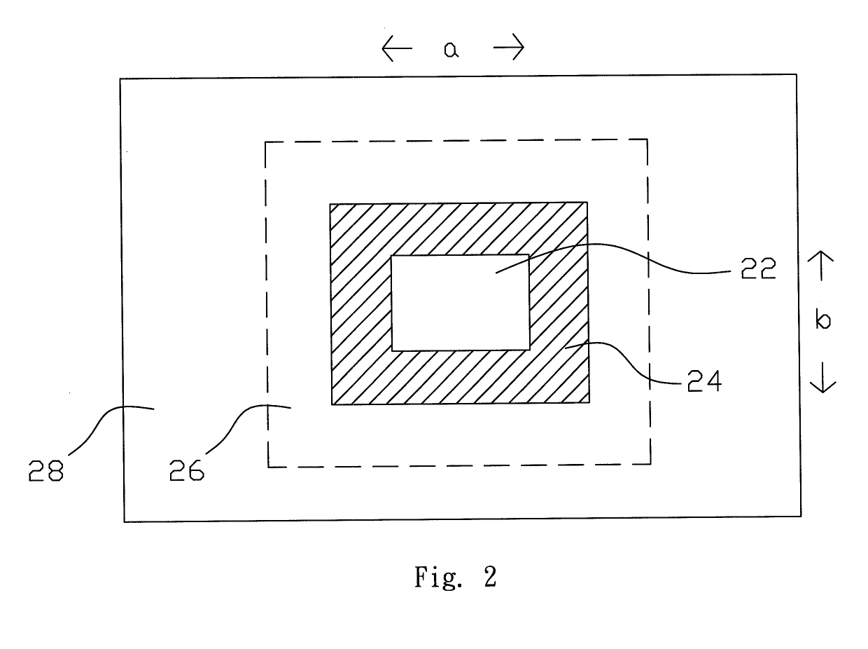

(4) Set the detected range of the primary target area as the primary target area, and set a secondary target area 18. According to the theory of visual psychology, people have a primary target area (such as an eye-catching area, a focus area or a core area) in a scene perceived their eyes, and the primary target area is out most attentive area), so that the detected range of the primary target area for each of the aforementioned movie types is set as each respective primary target area. The present invention adopts the primary target area in accordance with the theory of visual psychology together with the technology of converting 2D images into 3D images. With reference to FIG. 2 together, the movies, the display area of a movie with a×b (such as 1920×1080) pixels is set as a primary target area 22, and the primary target area 22 is the detected range of the primary target area for different movie types, and the range of the primary target area of a first secondary target area 24 and the farthest secondary target area 28 is disposed at positions extended from the edges of the primary target area 22, wherein a middle secondary target area 26 is disposed between the first secondary target area 24 and the farthest secondary target area 28, and the middle secondary target area 26 comprises a second secondary target area, a third secondary target area, and the like gradually expanded and disposed at positions extended from the edges of the first secondary target area 24, and the first secondary target area 24, the middle secondary target area 26 and the farthest secondary target area 28 are generally called the secondary target areas.

(5) Perform a 2D-image object depth computation 20 to the primary target area and the secondary target area.

In the present invention, a pixel is the smallest unit of an image. For example, the 800×600 image is an image having 800 pixels along the X-axis, 600 pixels along the Y-axis, and a total of 800×600=480000 pixels. If the image requires a fine computation of the depth of the 2D-image object, then 1×1 pixel is used as a unit. If it is necessary to save computing resources, then a larger number of pixels (such as 8×8) are used as a unit for the computation.

In the aforementioned 2D-image object depth computation 20 of the primary target area and the secondary target area, the primary target area 22, the first secondary target area 24 the middle secondary target area 26 and the farthest secondary target area 28 are processed, wherein the primary target area 22 uses a finer method for computing the depth of the 2D-image object, such as using 1×1 pixel or 2×2 pixels of the primary target area 22 as a unit for the computation, and the first secondary target area 24 forms a boundary of the first secondary target area 24 an appropriate pixel area (such as 20 to 80 pixels, but not limited to such condition only) extended from an edge of the primary target area 22, and the first secondary target area 24 uses a larger number of pixels than that of the primary target area 22 as a unit such as 2×2 pixels or 4×4 pixels for computing the depth of the 2D-image object. Similarly, the second secondary target area the middle secondary target area 26 forms a boundary of the second secondary target area the middle secondary target area 26 in an appropriate pixel area (such as 20 to 80 pixels) extended from an edge of the first secondary target area 24, and the second secondary target area 26 uses a larger number of pixels such as 4×4 pixels or 8×8 pixels than that of the first secondary target area 24 as a unit for computing the depth of the 2D-image object; and the farthest secondary target area 28 is disposed at a less attentive area, so that the farthest secondary target area 28 uses a larger number of pixels such as 8×8 pixels as a unit for computing the depth of the 2D-image object.

If the middle secondary target area 26 is a plurality of the aforementioned areas such as the second, third and fourth secondary target areas, each pixel area will use an increasingly larger number of pixels as a unit for the computation of the depth of the image object.

The aforementioned method for computing the depth of the 2D-image object includes the following methods or a combination of the following methods:

A. Object Depth Based on Relative Motion Analysis: When a camera is moving, a near object is moving faster, and a far object is moving slower, and the depth information of each object is calculated based on such phenomenon.

B. Contrast Intensity Analysis: Generally speaking, a near object has a higher brightness, and a far object has a lower brightness, and the depth information of each object is calculated based on such phenomenon.

Other methods for computing the depth of the 2D-image object include a geometric analysis, a motion parallax analysis, and defocus blur analysis, etc, and all these methods are conventional methods for computing the depth of the 2D-image object, and thus will not be described in details here.

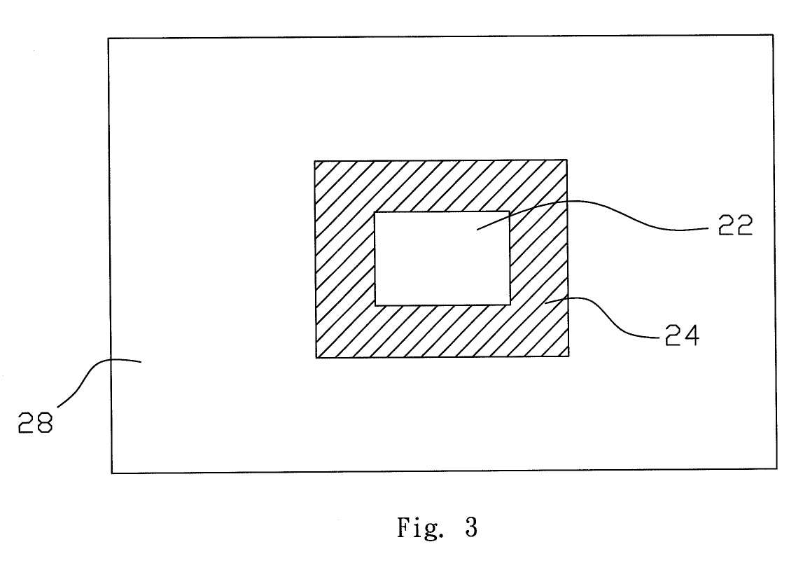

Compared with the prior art, the method for computing the depth of the 2D-image object in accordance with the present invention can save lots of computing resources. In FIG. 3, a screen with 1920×1080 pixels is used for the illustration as follows:

The prior art generally uses 2×2 pixels as a unit for the computation, and the number of required computing units is (1920×1080)÷4=518400. In the primary target area 22 of the present invention, the length and width define a square area of 300×300 pixels, and 2×2 pixels in this area are used as a unit for the computation, and the number of computing units is (300×300)÷4=22500.

In the first secondary target area 24 of the present invention, the length and width define a square area with 380×380 pixels minus the area of the primary target area 22, and 4×4 pixels in this area are used as a unit for the computation, and thus the number of computing units is [(380×380)−(300×300)]÷16=3400.

In the farthest secondary target area 28 of the present invention, a full screen minus the areas of the primary target area 22 and the first secondary target area 24, such as 8×8 pixels are used as a unit for the computation, and thus the number of computing units is [(1920×1080)−(380×380)]÷64=30144.

Therefore, the total number of computing units of the present invention is 22500+3400+30144=56044.

In the data of the aforementioned computing units, the computing resource consumed by the computation of the depth of the 2D-image object in this preferred embodiment of the present invention is compared with the prior art as follows:

Since 56044÷518400=0.108, the number of computing units used in the preferred embodiment of the present invention is approximately one-tenth of that of the prior art, and the computing resource consumed by the computation of the depth of the 2D-image object in this preferred embodiment of the present invention is also one-tenth of that of the prior art. Obviously, the present invention can save the computing resource significantly. In other words, the conventional method of computing the depth of the 2D-image object uses 1×1 pixel or 2×2 pixels in a full screen as a unit for the computation, and this it requires a large consumption of the computing resource, or even requires a specified video chip or video card for completing the computation of the depth of the 2D-image object. On the other hand, the present invention detects the primary target area according to different movie types, and derives the first secondary target area, second secondary target area, and the farthest secondary target area and gives different weights to them by a gradient method for the computation. The farther the secondary target area, the larger number of pixels is used as a computing unit, such that the resource for converting 2D images into 3D images can be reduced significantly to make the real-time conversion process smoother and allow users to view 3D movies or pictures in a more economic way.

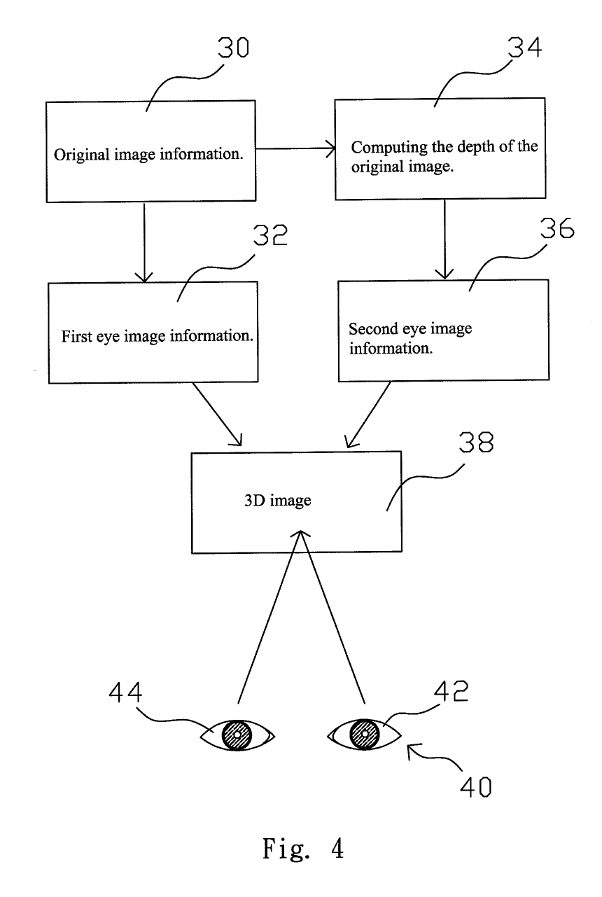

In the method of computing the depth of the 2D image object in accordance with the present invention 2D image, the method of converting 2D images into 3D images is further illustrated below. With reference to FIG. 4, the method comprises: original image information 30, serving as first-eye image information 32, wherein the first-eye image information 32 is the information of a left eye (or a right eye) image, and the original image information 30 is computed by the aforementioned method of computing the depth of the 2D image object (which is the process of computing the depth of the original image 34) to obtain second-eye image information 36 with depth information, and the second-eye image information 36 (or the in-depth image) is converted into information of the right eye (or left eye) image, so that the left eye image and the right eye image are combined into a superimposed image. A 3D image 38 is shown after a pair of 3D glasses (not shown in the figure) is worn at the left eye and right eye 44, 42 of a viewer 40.

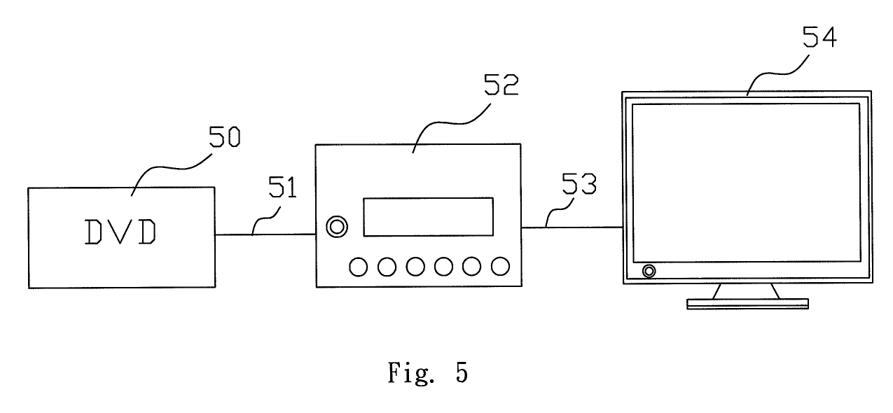

With reference to FIG. 5 for a schematic view of an image processing device of a method of converting 2D images into 3D images in accordance with a first preferred embodiment of the present invention, the image processing device adopts the method of converting 2D images into 3D images in accordance with the present invention, the method can be written into a chip or a plurality of chips or a carrier and the chip(s) are built in the image processing device, and the image processing device includes a conversion box 52, and the conversion box 52 includes a 3D function key and/or a plurality of selection keys, and the 3D function key and the plurality of selection keys are combined and used together with the method of converting 2D images into 3D images. The selection keys include a news, sport, movie, advertisement, adult, or general movie type function key provided for a user to select and set a movie type, and an end of the conversion box 52 is coupled to a 2D image signal providing apparatus 50 through a HDMI connecting line 51 (or another signal interface connecting line) to, the image signal providing apparatus 50 can be a television (that provides wireless TV signals or cable TV signals), a DVD player (that provides a play signal), a game set (that provides a play signal), and a modem (that provides an Internet signal) etc, wherein the conversion box 52 is provided for receiving the signal, and another end of the conversion box 52 is coupled to a display device 54 through the HDMI connecting line 53 (or another signal interface connecting line), and the display device 54 can be a television, a display device, a projector, a digital photo frame, a video phone used for displaying a 3D image (or a photo), and the conversion box 52 may not come with the plurality of selection keys, but perform the conversion directly. Now, the general movie type is generally used as an option for converting 2D images into 3D images.

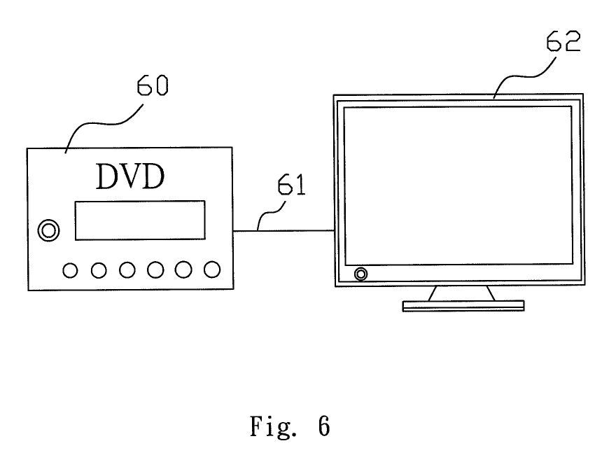

With reference to FIG. 6 for an image processing device using the method of converting 2D images into 3D images in accordance with a second preferred embodiment of the present invention, the image processing device uses the method of converting 2D images into 3D images of the present invention, wherein the method is written into a chip or a plurality of chips or a carrier, and the chip(s) are built in the image processing device, and the image processing device is a player 60 which can be a television or a DVD player. The player 60 includes a plurality of selection keys, and the selection keys include news, sport, movie, advertisement, adult, and general movie type function keys provided for an operator to select and set a movie type, and an end of the player 60 is coupled to a display device 62 through a HDMI connecting line 61 (or another signal interface connecting line), and the display device 62 can be a television or a display device for displaying a 3D image (or photo), and the player 60 may have a 3D function key for enabling the function of converting 2D images to 3D images in accordance with the present invention, or may not have a selection key but perform the conversion directly (wherein the general movie type is generally used as an option for converting 2D images into 3D images).

The player 60 and the display device 62 can be integrated into a play and display device (not shown in the figure), and the play and display device can be a television (including LCD, LED and CRT televisions), a monitor (including LCD, LED and CRT monitors), a mobile phone, a projector, and a digital photo frame. Similarly, the play and display device can have a 3D function key for enabling the function of converting 2D images to 3D images in accordance with the present invention and further comprise the news, motion, movie, advertisement, adult, and general movie type selection keys, or may not have a selection key but perform the conversion directly (wherein the general movie type is generally used as an option for converting 2D images to 3D images.)

In the method of converting 2D images into 3D images of the present invention, the method can be written into a chip or a plurality of chips, and the chip(s) can be installed in an interface card (not shown in the figure), wherein the interface card is a display card, or a video card, or a network card, and the interface card is installed in a computer for assisting the operation of converting 2D images to 3D images.

The method of converting 2D images into 3D images of the present invention can be implemented by software, and the software includes news, sport, movie, advertisement, adult, and general movie type function options, or may not include any function option but perform the conversion directly (wherein the general movie type is generally used as an option for converting 2D images to 3D images), and the software can be installed in various types of computers (such as a netbook and a panel computer), an e-Book, a multimedia player, a MP3 player, a MP4 player, a mobile phone, a display device, a monitor, a television, and a PC game set, etc.

With the aforementioned method and apparatus of the present invention, different movie types can be used for detecting the most attentive primary target area and derives a less attentive secondary target area and combining with the technology of converting 2D images to 3D images in order to produce 3D images with less computing resource, and provide an economic way of producing the 3D images and promote the application of converting 2D images to 3D images.

In summation of the description above, the present invention complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A method of converting 2D images into 3D images, comprising:
(1) detecting a range of a primary target area of a movie;
(2) setting the detected range of the primary target area as a primary target area and setting a secondary target area, wherein the secondary target area is disposed at a position extended from an edge of the primary target area;
(3) performing a 2D-image object depth computation of the primary target area and the secondary target area, wherein the primary target area uses a smaller pixel as a unit for computing the depth of the 2D-image object, and the secondary target area uses a larger number of pixels than that of the primary target area as a unit for computing the depth of the 2D-image object.

2. The method of converting 2D images into 3D images as recited in claim 1, further comprising the step of selecting a movie type before the step (1) takes place, wherein the movie type can be selected and set by a press key or a software menu.

3. The method of converting 2D images into 3D images as recited in claim 1, wherein the detection method used for detecting the range of the primary target area of the movie in the step (1) is one selected from the collection of a face detection, a body detection, a ball detection, a text detection, a skin color detection, a general detection and a combination of the above.

4. The method of converting 2D images into 3D images as recited in claim 1, wherein the secondary target area comprises at least a first secondary target area and the farthest secondary target area disposed at a position extended from an edge of the first secondary target area.

5. The method of converting 2D images into 3D images as recited in claim 1, wherein the primary target area uses 1×1 pixel or 2×2 pixels as a unit for computing the depth of the 2D-image object.

6. The method of converting 2D images into 3D images as recited in claim 4, wherein the first secondary target area uses 2×2 pixels or 4×4 pixels as a unit for computing the depth of the 2D-image object.

7. A method of converting 2D images into 3D images, comprising:
an original image, serving as first-eye image information;
an in-depth image, for setting a primary target area and a secondary target area of the original image in a movie, and the secondary target area being disposed at a position extended from an edge of the primary target area, and the primary target area using a smaller pixel as a unit for computing the depth of the 2D-image object, and the secondary target area using a larger number of pixels than that of the primary target area as a unit for computing the depth of the 2D-image object, and the 2D image of the primary target area and the secondary target area being converted into a 3D image, which is the in-depth image serving as second-eye image information;
combining the original image and the in-depth image into a superimposed image, which can be shown as the 3D image through 3D glasses.

8. The method of converting 2D images into 3D images as recited in claim 7, wherein the secondary target area comprises at least a first secondary target area and the farthest secondary target area disposed at a position extended from an edge of the first secondary target area.

9. The method of converting 2D images into 3D images as recited in claim 7, wherein the primary target area uses 1×1 pixel or 2×2 pixels as a unit for computing the depth of the 2D-image object.

10. The method of converting 2D images into 3D images as recited in claim 8, wherein the first secondary target area uses 2×2 pixels or 4×4 pixels as a unit for computing the depth of the 2D-image object.

11. A method of converting 2D images into 3D images, comprising an in-depth image, wherein the in-depth image is obtained by performing a depth computation process to an image, and the in-depth image includes a primary target area and at least one secondary target area, and the secondary target area is disposed at a position extended from an edge of the primary target area, and the primary target area uses a smaller pixel as a unit for computing the depth of the 2D-image object, and the secondary target area uses a larger number of pixels than that of the primary target area as a unit for computing the depth of the 2D-image object.

12. The method of converting 2D images into 3D images as recited in claim 11, wherein the secondary target area comprises at least a first secondary target area and the farthest secondary target area disposed at a position extended from an edge of the first secondary target area.

13. The method of converting 2D images into 3D images as recited in claim 11 wherein the primary target area uses 1×1 pixel or 2×2 pixels as a unit for computing the depth of the 2D-image object.

14. The method of converting 2D images into 3D images as recited in claim 11, wherein the first secondary target area uses 2×2 pixels or 4×4 pixels as a unit for computing the depth of the 2D-image object.
